(19) United States
(12) Patent Application Publication
(10) Pub. No.: US 2026/0254847 A1
(43) Pub. Date: Aug. 27, 2026

(54) AI-BASED AGENT FOR MITIGATION OF DISTRIBUTED DENIAL-OF-SERVICE (DDoS) ATTACKS USING ARTIFICIAL INTELLIGENCE MODELS

(71) Applicant: Radware Ltd., Tel Aviv (IL)

(72) Inventors: Maor UZIEL, Azor (IL); David AVIV, Tel Aviv (IL); Gabi NAKIBLY, Tel Aviv (IL)

(73) Assignee: Radware Ltd., Tel Aviv (IL)

(21) Appl. No.: 19/064,034

(22) Filed: Feb. 26, 2025

(51) Int. Cl. H04L 9/40

(52) U.S. Cl. CPC H04L 63/1458; H04L 63/1425

(57) ABSTRACT

A method and system for analyzing and determining a mitigation action for a distributed denial of service (DDoS) attack are provided. The method includes receiving, by an agent, an input request from a security tool, wherein the input request includes traffic patterns indicative of an ongoing DDoS attack; generating, by the agent, a prompt for a generative AI model based on at least the input request, wherein the prompt, when processed by the generative AI model, returns a recommended mitigation action to mitigate the DDoS attack, wherein the mitigation action includes at least instructions to modify at least one security policy set with the security tool; and feeding, by the agent, the at least instructions to the security tool, wherein the at least instructions, when executed by the security tool, cause the security tool to modify at least one security policy in real-time to mitigate the DDoS attack.

### TECHNICAL FIELD

The present disclosure generally relates to cybersecurity systems and, more particularly, to an incident response system.

### BACKGROUND

An Emergency Response Team (ERT) in cybersecurity is a specialized group responsible for detecting, responding to, and mitigating security incidents, such as cyber-attacks or data breaches. Their role includes monitoring networks, containing threats, conducting forensic analysis, and restoring systems to normal operations. ERTs also communicate with internal stakeholders, law enforcement, and regulatory bodies, ensuring proper incident management. They proactively work to strengthen an organization's defenses through vulnerability assessments and training, and after incidents, they analyze and report on the event to improve future response strategies. ERTs play a crucial role in minimizing damage, ensuring compliance, and enhancing organizational resilience against cyber threats.

Attackers may leverage large-scale Distributed Denial-of-Service (DDoS) attacks using Internet of Things (IoT) botnets or employ watering hole attacks by compromising legitimate websites frequented by the target group. A DDoS attack is a malicious attempt to disrupt the normal traffic of a targeted server, service, or network by overwhelming the target or its surrounding infrastructure with a flood of Internet traffic. Due to the complexity and stealth of these methods, organizations must adopt a multi-layered defense strategy that includes advanced threat detection, incident response plans, and continuous monitoring to mitigate these sophisticated threats.

Detecting DDoS attacks is difficult because attackers use advanced evasion techniques, which exploit legitimate tools and avoid traditional security measures to execute complex cyber-attack vectors. The lack of real-time monitoring and insufficient expertise of ERT further complicates detection efforts, making these attacks highly challenging to identify and mitigate in a timely manner.

It would, therefore, be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some aspects” or “certain aspects” may be used herein to refer to a single embodiment or multiple embodiments of the disclosure.

A method of one or more computers can be configured to perform particular operations or actions by virtue of having software, firmware, hardware, or a combination of them installed on the system that, in operation, causes or cause the system to perform the actions. One or more computer programs can be configured to perform particular operations or actions by virtue of including instructions that, when executed by a data processing apparatus, cause the apparatus to perform the actions.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, the method may include receiving, by an agent, an input request from a security tool, where the input request includes traffic patterns indicative of an ongoing DDoS attack; generating, by the agent, a prompt for a generative AI model based on at least the input request, where the prompt, when processed by the generative AI model, returns a recommended mitigation action to mitigate the DDoS attack, where the mitigation action includes at least instructions to modify at least one security policy set with the security tool; and feeding, by the agent, the at least instructions to the security tool, where the at least instructions, when executed by the security tool, cause the security tool to modify at least one security policy in real-time to mitigate the DDoS attack. Other embodiments of this aspect include corresponding computer systems, apparatus, and computer programs recorded on one or more computer storage devices, each configured to perform the actions of the methods.

Implementations may include one or more of the following features. The method may include: instantiating the agent to communicate with the security tool deployed in an organization, where the security tool detects a DDoS attack. The method may include: instantiating a plurality of agents, where each of the plurality of agents communicates with a different security tool configured for detecting a different type of DDoS attack. The method where generating the prompt further may include: computing attack vectors based on the received traffic patterns. The method where computing the attack vectors further may include: aggregating the received traffic patterns; identifying a plurality of attack vectors in the aggregated traffic patterns; consolidating the plurality of attack vectors into a merged attack vector; and generating at least one mitigation action based on key characteristics of the merged attack vector. The method where generating the prompt further may include: generating the prompt based on a predefined template, the input request, and the merged attack vector. The method may include: configuring the agent with the generative AI model; and training the generative AI model with security policies and capabilities of the security tool. The method where the traffic patterns demonstrate an ongoing DDoS attack, and where the input request further includes an attack-time request. The method where the request further includes any one of: a request to improve detection of the ongoing DDoS attack, a request to characterize the ongoing DDoS attack, and a request to improve mitigation of the ongoing DDoS attack. The method may include: instantiating a controller agent to communicate with the agent; and responding, by the controller agent, to attack reasoning queries submitted by a user. The method where the queries are natural language queries. The method where a traffic pattern of the input patterns in the input request includes any one of: rate-based traffic parameters, rate-invariant parameters, a communication protocol type, and a baseline determined during peacetime. Implementations of the described techniques may include hardware, a method or process, or a computer tangible medium.

In one general aspect, non-transitory computer-readable medium may include one or more instructions that, when executed by one or more processors of a device, cause the device to: analyze and determine a mitigation action for a distributed denial of service (DDoS) attack, having: receiving, by an agent, an input request from a security tool, where the input request includes traffic patterns indicative of an ongoing DDoS attack generate, by the agent, a prompt for a generative AI model based on at least the input request, where the prompt, when processed by the generative AI model, returns a recommended mitigation action to mitigate the DDoS attack, where the mitigation action includes at least instructions to modify at least one security policy set with the security tool; and feed, by the agent, the instructions to the security tool, where, when executed by the security tool, cause the security tool to modify at least one security policy in real-time to mitigate the DDoS attack. Other embodiments of this aspect include corresponding computer systems, apparatus, and computer programs recorded on one or more computer storage devices, each configured to perform the actions of the methods.

In one general aspect, the system may include one or more processors configured to: receive, by an agent, an input request from a security tool, where the input request includes traffic patterns indicative of an ongoing DDoS attack. The system may furthermore include generating, by the agent, a prompt for a generative AI model based on at least the input request, where the prompt, when processed by the generative AI model, returns a recommended mitigation action to mitigate the DDoS attack, where the mitigation action includes at least instructions to modify at least one security policy set with the security tool. The system may in addition include feeding, by the agent, the instructions to the security tool, where the instructions, when executed by the security tool, cause the security tool to modify at least one security policy in real-time to mitigate the DDoS attack. Other embodiments of this aspect include corresponding computer systems, apparatus, and computer programs recorded on one or more computer storage devices, each configured to perform the actions of the methods.

Implementations may include one or more of the following features. The system where the one or more processors are further configured to: instantiate the agent to communicate with the security tool deployed in an organization, where the security tool detects a DDoS attack. The system where the one or more processors are further configured to: instantiate a plurality of agents, where each of the plurality of agents communicates with a different security tool configured for detecting a different type of DDoS attack. The system where the one or more processors, when generating the prompt, are configured to: compute attack vectors based on the received traffic patterns. The system where the one or more processors, when computing the attack vectors, are configured to: aggregate the received traffic patterns; identify a plurality of attack vectors in the aggregated traffic patterns; consolidate the plurality of attack vectors into a merged attack vector; and generate at least one mitigation action based on key characteristics of the merged attack vector. The system where the one or more processors, when generating the prompt, are configured to: generate the prompt further based on a predefined template, the input request, and the merged attack vector. The system where the one or more processors are further configured to: configure the agent with the generative AI model; and train the generative AI model with security policies and capabilities of the security tool. The system where the traffic patterns demonstrate an ongoing DDoS attack, and where the input request further includes an attack-time request. The system where the request further includes any one of: a request to improve detection of the ongoing DDoS attack, a request to characterize the ongoing DDoS attack, and a request to improve mitigation of the ongoing DDoS attack. The system where the one or more processors are further configured to: instantiate a controller agent to communicate with the agent; and respond, by the controller agent, to attack reason queries submitted by a user, where the queries are natural language queries. The system where a traffic pattern of the input patterns in the input request includes any one of: rate-based traffic parameters, rate-invariant parameters, a communication protocol type, and a baseline determined during peacetime. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 shows an example network diagram utilized to describe the various disclosed embodiments.

FIG. 2 shows an example of a diagram of a system utilized to carry the disclosed embodiments.

FIG. 3 shows an example flow diagram of various analysis engines of the agent.

FIG. 4 shows an example functional diagram of an agent according to an embodiment.

FIG. 5 is a flowchart of an example process for modifying security policies of security tools to mitigate DDoS attacks according to an embodiment.

FIG. 6 is a flowchart of an example process for analyzing and determining mitigation actions for DDoS attacks according to an embodiment.

FIG. 7 is an example schematic diagram of a system according to an embodiment.

### DETAILED DESCRIPTION

The various disclosed embodiments include a method and system for agentic analysis and mitigation of distributed denial-of-service (DDoS) attacks using an artificial intelligence (AI) model.

The system may instantiate various agents that are configured to perform various processes for the system. The system may, by the agents, receive traffic patterns to determine if there is a DDoS attack. The system may, by the agents, pre-process (aggregate) the large amount of traffic patterns data into a format that is suitable for input as a prompt into a Large Language Model (LLM). Additionally, the system may, by the agents, classify and divide the aggregated data based on different dimensions of the data. Each divided subset of the aggregated data is inputted into an LLM, which is tasked with examining a subset of data and identifying attack vectors from the data. Attack vectors are patterns in the traffic data that indicate a particular method or pathway of a cyber-attack. The aggregated data is classified based on the dimension of the data, which includes, but is not limited to, communication protocols, source IP addresses, ports, fragmentation, and packet size. Dividing the aggregated data by dimensions serves to give each AI model enough context that allows it to identify attack vectors but does not overwhelm it with too many tasks in one prompt.

The system may, by the agents, merge the AI-identified attack vectors, which represent different dimensions of the attack. Attack vectors identified by the separate AI models may describe different dimensions of traffic data that are representative of the same DDoS attack. Thus, merging overlapping AI-identified attack vectors into a combined attack vector to create a clearer, more efficient representation of the attack. By reducing redundancy and emphasizing significant combinations, the main components of the attack are identified, allowing the most critical traffic characteristics to be pinpointed. This streamlined approach helps improve both the accuracy of analysis and the effectiveness of mitigation strategies.

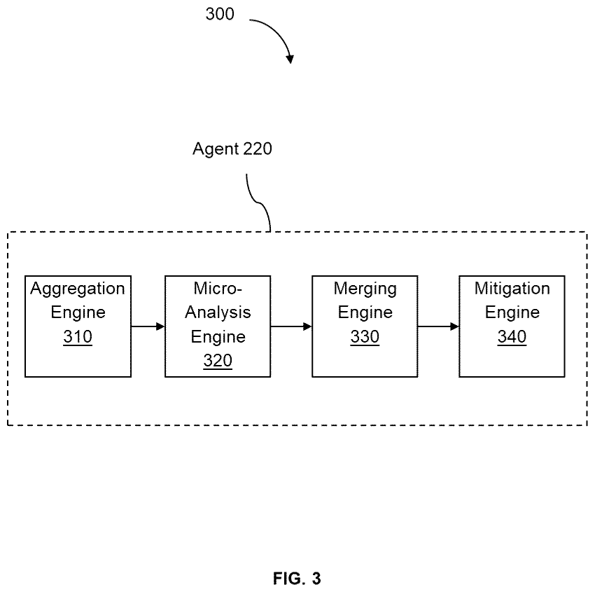

Further, the system may, by the agents, reduce redundant attack vectors identified by an AI model. Reducing redundant attack vectors serves to identify which attack vectors, when a mitigation effort is applied, will effectively mitigate the attack without disrupting the normal traffic of legitimate users on the network. Reducing redundancy of attack vectors according to various disclosed embodiments is discussed in more detail with respect to the mitigation engine 340, FIG. 3.

It should be appreciated that the disclosed system provides an improved technical solution to identify, analyze, and mitigate DDoS attacks in a timely manner without disrupting legitimate network traffic. It would further provide an improved technical solution to reduce the rate of false negative detection and false positive detection of DDoS attacks. This would also reduce the compute resources typically allocated to process faulty detection alerts and would improve overall cyber security in an organization.

It is recognized that a human can manually analyze traffic data to detect a DDoS attack. However, when doing so, a human applies subjective criteria to determine what dimensions and characteristics should be analyzed. Furthermore, different human operators may apply different subjective criteria, resulting in even more disparity in analyses. It is recognized that insufficient expertise of operators (ERT) complicates detection efforts, making DDoS attacks highly challenging to identify and mitigate in a timely manner.

The disclosed system solves this, in an embodiment, by at least segmenting traffic data, feeding the segmented data into separate AI models, merging overlapping attack vectors identified by the AI models, and choosing the optimal attack vectors on which to perform a mitigation effort, thereby enabling more accurate detection and effective mitigation of DDoS attacks while maintaining network traffic of legitimate users.

It has further been recognized that a human cannot manually segment traffic data, analyze each segment for attack vectors, and merge overlapping attack vectors in real-time, and thus analyze and mitigate DDoS attacks in real-time as traffic is received. Humans are incapable of doing so in real-time, where every second is crucial when dealing with DDoS attacks. While a human would be manually analyzing traffic data, a hacker may exploit a cybersecurity weakness, vulnerability, and the like, which is why speed is of the essence.

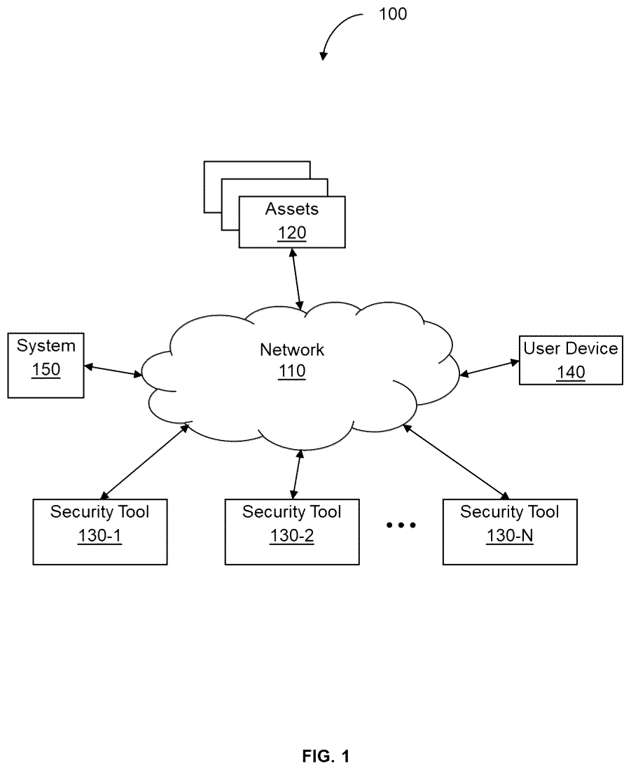

FIG. 1 shows an example network diagram 100 utilized to describe the various disclosed embodiments. In the example network diagram 100, a plurality of assets 120, a plurality of security (sec) tools 130-1 through 130-N (hereinafter referred to individually as a security tool 130 and collectively as security tools 130, merely for simplicity purposes), a user device 140, an AI-based system 150 (or simply system 150), communicate via a network 110. Network 110 may be, but is not limited to, a wireless, cellular, or wired network, a Local Area Network (LAN), a Wide Area Network (WAN), a Metro Area Network (MAN), the Internet, the World Wide Web (WWW), similar networks, and any combination thereof. Network 110 may include or be part of a cloud computing platform, such as a public cloud, a private cloud, or a hybrid cloud.

Assets 120 may include any computing resources, physical or virtual, in an enterprise or organization protected by the security tools 130. Assets 120 may include servers, databases, computers, network devices, virtual machines, containers, serverless, and the like. Assets 120 may be deployed on-premises or on a cloud computing platform.

Security tools 130 are used to protect systems, networks, and data from threats. These tools help with tasks such as monitoring, detecting, preventing, and responding to cyber-attacks. Examples of security tools 130 include Intrusion Detection and Prevention Systems (IDPS), Endpoint Protection and Detection (EPD), firewalls, vulnerability, scanning, and management, network monitoring and analysis, DDoS detection mitigation, Data Loss Prevention (DLP), Application Programming Interface (API) security system, and the like. Security tools 130 are equipped with automatic detection and/or mitigation capabilities.

In an embodiment, security tools 130 may include various security tools for detecting, analyzing, and mitigating different types of DDoS attacks (e.g., application-layer DDoS attacks, network DDoS attacks, and others). In an embodiment, each security tool 130 may be designed to handle various components of a DDoS attack. Security tools 130 may not necessarily analyze the reason for the DDoS attack.

When DDoS attacks are not detected, or detected but not mitigated, or partially detected and/or mitigated, indicative information or signals are sent to an ERT (e.g., a user operating a user device 140). An ERT user may perform operations to investigate the indicative information to characterize the ongoing attack and decide on potential mitigation actions. The user device (UD) 140 may be but is not limited to, a personal computer, a laptop, a tablet computer, a smartphone, a wearable computing device, or any other device capable of receiving and displaying notifications.

As mentioned above, the lack of real-time monitoring, weaknesses in security tools 130, and insufficient expertise of an ERT further complicate detection efforts, making DDoS attacks highly challenging to identify and mitigate in a timely manner. In the world of cybersecurity, an ERT may take days to investigate an ongoing attack, during which significant damage can occur.

The disclosed system 150 is an AI-based system or agent that can provide an immediate response to indicative information received from tools 130, investigate an ongoing attack, and command and execute mitigating actions to block the attack.

System 150 can further reason a detected DDoS attack. DDoS attack reasoning refers to the motivation, methods, and logic behind why and how DDoS attackers target systems, networks, or data. Understanding the reasoning behind a DDoS attack allows one to anticipate threats, build better defenses, and effectively respond to incidents. DDoS attack reasoning performed by system 150 allows for updating the security policies (defined below) for the security tools 130 with regard to performing mitigation actions for various types of DDoS attacks.

In an embodiment, system 150 analyzes the security policies of security tools 130 and updates such policies during peacetime. The recommendation on revisions of security policies can be based on peacetime traffic patterns fed by security tools 130 into system 150. In cybersecurity, a security policy is a set of rules and configurations that dictate how the tool should act to protect systems, networks, or data from threats. These policies cover areas like access control, network security, data protection, intrusion detection, and incident response. They define actions such as blocking suspicious traffic, managing user permissions, encrypting data, applying patches, and responding to breaches. Policies are essential for tailoring the behaviors of the security tools 130 to meet an organization's specific security needs and prevent cyberattacks. Typically, the policies are set by a user (a human operator). As such, the defined policies may not be accurate or optimized. As noted above, manually setting policies may increase the false positive rate of attacks. Therefore, modifying and refining the policies of security tools 130 would reduce the false positive rate of attacks. As will be discussed below, the modification of policies is performed in real-time and during peacetime as traffic is received, processed, and monitored by security tools 130. It should be noted that the modification of such policies may occur as the respective security tools 130 are onboarded to system 150.

According to some embodiments discussed in detail above, system 150 may include a plurality of agents, and each agent is assigned to a security tool 130. Thus, an agent may investigate, detect, or respond to a certain type of DDoS attack or incident. An agent can maintain and recommend updates to the security policies of the security tools 130 during runtime. The architecture of such an agent is discussed with reference to FIG. 3.

In an embodiment, system 150 may receive indicative information from a security tool 130 (e.g., a DDoS detection system). Such information may be reported when security tool 130 cannot handle the attack. System 150 generates a prompt based on indicative information and potential metadata from external resources. The generated prompt is fed to an AI model trained on a specification of a “corresponding” security tool 130. The output of the AI model is a set of instructions for configuring the security tool to detect or mitigate the ongoing attack. In an embodiment, the set of instructions may include new or revised security policies to configure the security tool 130 to perform various mitigation actions on network traffic associated with various types of DDoS attacks. In an embodiment, the AI model is a Large Language Model (LLM) trained on the security tool 130.

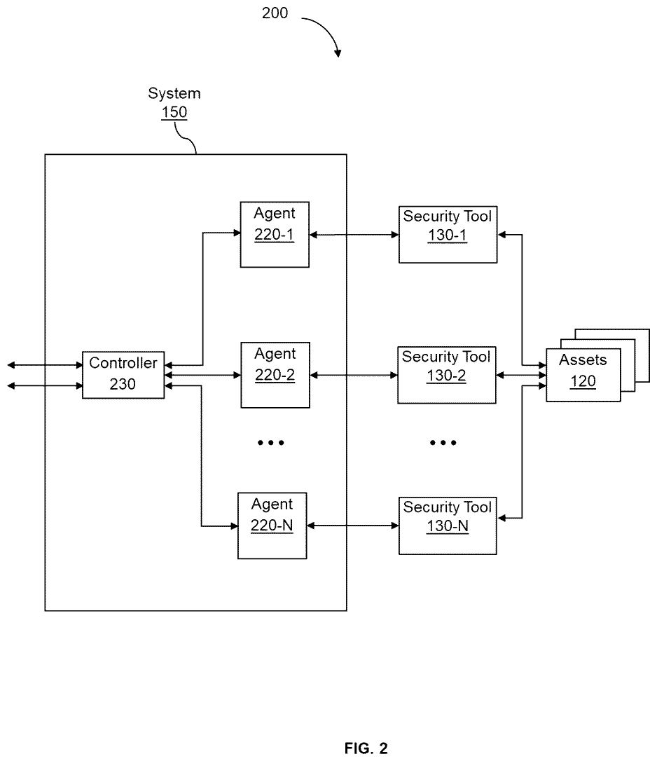

FIG. 2 shows an example of a diagram of system 150 according to an embodiment. System 150 includes a plurality of agents 220-1 through 220-N, each of which is associated with a security tool 130-1 through 130-N, respectively. A security tool 130 may detect and/or mitigate various types of DDoS attacks triggered against the protected assets 120. Security tools 130 and assets 120 are discussed above in more detail. System 150 may further include a controller 230.

An agent (e.g., agent 220-1) is configured to receive indicative information on a potential or ongoing DDoS attack from a security tool (e.g., tool 130-1). Agent 220-1 generates a prompt based on at least the indicative information and feeds the generated prompt to an AI model to provide a response to security tool 130-1 on how to respond to the potential attack. In an embodiment, agent 220-1 returns to the tool 130-1 instructions on detecting or blocking the attack. For example, tool 130-1 may be a DDoS detection tool, and the indicative information may include telemetric data collected by tool 130. Such data may include a source IP address of a suspicious machine, suspicious traffic patterns, granular data on network flows, and the like. Agent 220-1 may send instructions to tool 130-1 to change detection thresholds at tool 130-1. The instructions may be in a format for JSON, a script, or other type configuration files. The AI model embedded in each agent 220-1 is trained with the specification of, for example, a DDoS detection tool.

The prompt may be generated using metadata retrieved from one or more external sources. For example, agent 220-1 can request such data from external sources (not shown) through controller 230. For example, external data sources may include reputation services, threat analysis reports, vulnerability databases, and the like. Controller 230 may include LLM metadata that may be received by querying controller 230.

Controller 230 may also provide an interface to a user (via user device 140), allowing the user to feed prompts to system 150 using a natural language. For example, a user submits queries related to the attack reasoning. Such questions may include what happened, when it happened, and why it happened. Any prompt that can be answered by agent 220 can be input to system 150.

Further, controller 230 can receive feedback from multiple agents 220 that participated in detecting and/or mitigating DDoS attacks. Controller 230 may cross-correlate such feedback to identify attack vectors that involve multiple stages. Each stage of such an attack vector may be identified by an individual agent 220, while controller 230 analyzes the sequence of the DDoS attack and instructs agent 220 on how to handle the attack vectors. Agent 220, when instructed by controller 230, may generate and send instructions to its respective tool 130-1.

The disclosed system 150 provides an ongoing incident response by allowing the continuous process of managing, mitigating, and resolving incidents (attacks) while such incidents are actively occurring. System 150 involves real-time actions to control and minimize the damage caused by the incidents, gathers information about the attack from tools 130, and implements immediate remediation efforts by the agent 220. During ongoing incident response, system 150 continuously and automatically operates to contain the threat and ensure the organization's assets 120 are protected.

It should be understood that the operations of system 150 described herein cannot be performed using the human mind or by paper and pencil. Moreover, a human operator applies subjective criteria to select, simulate, and/or predict, leading to results that are not consistent between different human operators, and often not consistent between the same human performing the same task repeatedly, in particular at the speeds required to provide an operable solution. The number of possible permutations for analyzed threats, security processes, policies, and parameter value selection far exceeds any practical use of the human mind. Thus, implementing the teachings discussed herein by system 150 allows for better security and faster response to cyber incidents.

FIG. 3 shows an example flow diagram 300 of various analysis engines of the agent 220. In an embodiment, the agent 220 includes an aggregation engine 310, a micro-analysis engine 320, a merging engine 330, and a mitigation engine 340.

The aggregation engine 310 receives traffic patterns from the security tools 130 and/or from various sources including any network-connected devices.

Each data point of the traffic pattern represents rate-based or rate-invariant metrics, such as average and maximum bits per second (BPS) and packets per second (PPS). In an embodiment, these metrics are taken at one-minute intervals. In a further embodiment, traffic patterns from the same weekday over the past four weeks are gathered by the aggregation engine 310 of the system 150, focusing on the time frame that includes two hours before and two hours after the time of the suspected attack. According to this embodiment, system 150 calculates if the observed traffic during the suspected period significantly exceeds baseline averages and standard deviations of network traffic, thereby confirming the presence of a potential DDoS attack. The system 150 may ascertain the presence of a DDoS attack or if the triggered alert is a false positive.

Additionally, in another embodiment, 24 hours of traffic before the attack, and allowed traffic during the attack, are gathered. In an embodiment, traffic for the 24 hours before the attack and traffic during the attack are gathered by aggregation engine 310 of the system 150. If, at some point, the allowed traffic deviates from the mean of the peacetime traffic by three standard deviations, the attack is considered partially mitigated.

In an embodiment, the aggregation engine 310 aggregates the data points in traffic patterns. This aggregation reduces the volume of data, highlights key characteristics of network traffic associated with a DDoS attack, and transforms the raw data into a human-readable format such that the aggregated data can be used in a prompt configured to be inputted into an LLM.

In one embodiment, the aggregation engine 310 may use a dynamic aggregation technique. According to this embodiment, the first one-minute interval is considered as an initial segment of data. For each subsequent one-minute interval, it is checked whether the traffic deviates significantly from the mean traffic of the current segment. For example, the aggregation engine 310 checks whether the BPS or PPS deviates significantly from the mean BPS or mean PPS of the current segment. In an embodiment, a significant deviation from the mean is defined as a deviation that is a pre-determined number of standard deviations from the mean.

In an embodiment of a dynamic aggregation technique, the data aggregation executes the following procedure to compress the data and highlight peaks in network traffic. If the traffic of a subsequent interval shows no significant deviation from the mean traffic of the current segment, the aggregation engine 310 adds the subsequent interval to the current segment. If, however, the traffic of a subsequent interval shows a significant deviation from the mean traffic of the current segment, the aggregation engine 310 closes the current segment and starts a new segment. Subsequent segments are checked by the aggregation engine 310 until all intervals are processed. This embodiment of a dynamic aggregation technique provides granular detail of the attack traffic, highlighting periods of spikes in network traffic, and it compresses data by grouping stable traffic intervals, resulting in fewer segments compared to the traffic patterns.

In another embodiment, the aggregation engine 310 may use a static aggregation technique. According to this embodiment, all one-minute intervals are merged into two main segments. The first segment consolidates all network traffic before a DDoS attack, e.g., peacetime traffic. The second segment consolidates all network traffic during the DDoS attack, e.g., attack time traffic. This static aggregation technique provides a summarized view of general trends in the network traffic.

A micro-analysis engine 320 receives the aggregated data from the aggregation engine 310. According to this embodiment, the micro-analysis engine 320 receives the aggregated data and inputs different dimensions of the aggregated data as prompts into an AI model configured to analyze each dimension for an attack vector in the aggregated data. In an embodiment, different dimensions include, but are not limited to, communication protocols used in the attack, source IP addresses, and ports. The micro-analysis engine 320 is tasked with analyzing a respective dimension of the aggregated data identifying potential attack vectors. The micro-analysis engine 320 feeds the aggregated data and the particular dimension of the aggregated data into respective prompts that are inputted into an AI model. Dividing the aggregated data into specific tasks allows the AI model to focus on a specific task without overwhelming the AI model with too many tasks in one request.

A merging engine 330 receives the potential attack vectors identified by the micro-analysis engine 320. In an embodiment, the merging engine 330 receives the attack vectors identified by the AI model associated with the micro-analysis engine 320. The attack vectors identified include dimensions, keys, and traffic statistics. Each attack vector identified by the AI model associated with micro-analysis engine 320 represents a single characteristic (dimension) of the attack vector, which describes the same traffic from different perspectives.

The merging engine 330 merges overlapping characteristics of the attack vectors identified, which creates a more efficient, less redundant representation of the attack vector. Merging the attack vectors is achieved by the merging engine 330 identifying characteristics of the separate attack vectors that may describe, from different perspectives in the computing and networking environment, a single, consolidated attack vector. This merged attack vector highlights the main components of the attack vectors identified by the AI model associated with the micro-analysis engine.

In an embodiment, the merging agent executes the merger of overlapping characteristics of the separate attack vectors from the micro-analysis engine 320 by inputting the separate attack vectors into an AI model. Furthermore, combining attack vectors, according to the various disclosed embodiments, allows for more targeted mitigation than if the disclosed combination embodiments were not used. Such target mitigation entails precise defensive measures on certain network traffic associated with a DDoS attack and reduces any collateral impact on legitimate network traffic.

In an embodiment, the merging engine 330 may initialize a queue of separate attack vectors identified by the AI model associated with the micro-analysis engine 320. For the attack vectors in the queue, it is checked whether there is a subset of the attack vectors that have the same dimension, which is not a dimension of a selected vector (v1). If the characteristics of the subset of vectors sufficiently intersect with v1, v1 is replaced with the intersection of the vectors and each vector of the subset. This new replacement vector is a combination of the dimensions of v1 and the dimensions of each vector in the subset, including the key values for each vector. Additionally, any intersection vectors are added to the queue for further analysis e.g., analysis for further combining the vectors. If the characteristics of the subset of vectors do not sufficiently intersect with v1, v1 is maintained with its original dimensions.

According to this embodiment, the merged attack vector is used by an AI model to generate an attack summary, which provides an overview of attack patterns and insights into the attacker's methods. In an embodiment, this technique is executed through the use of an AI model.

According to this embodiment, the mitigation engine 340 is configured to choose which subset of attack vectors is most appropriate for the application of a traffic filter. A traffic filter serves to remove a subset of traffic that is associated with a DDoS attack from the network. In an embodiment, the appropriate subset of attack vectors on which to apply a traffic filter is the subset that has minimal redundancy (vectors have insufficient or no overlapping traffic), has the least collateral impact on legitimate traffic, and results in the most precise mitigation action.

A mitigation engine 340 receives an attack summary generated based on the merged attack vector and chooses which network traffic (associated with the merged attack vector) the security tools (e.g. security tools 130, FIG. 1) should target for the application of a traffic filter. In an embodiment, choosing the application of this traffic filter is based on a threshold value. The threshold value is set per user based on peak legitimate traffic seen during normal conditions e.g., peacetime. This threshold value serves to separate legitimate users from traffic associated with a DDoS attack. Additionally, the mitigation engine may measure how effective each traffic filter is by calculating the filter's blocking rate. The blocking rate is defined as the percentage of traffic that a traffic filter stops after accounting for legitimate traffic.

In a further embodiment, the mitigation engine 340 may use a redundancy reduction technique. According to this embodiment, the mitigation engine generates a tree of nodes that represent different dimensions of network traffic. Nodes may represent a communication protocol, a destination IP address, TCP flags, a source port, and a source IP address. Sibling nodes have separate, non-overlapping traffic, and the traffic of a child node is a subset of the traffic of its parent node. Applying a traffic filter to the parent node blocks all traffic from its child nodes. For example, a communication protocol node may be a parent node to a destination IP address node, and the destination IP address node may be a parent node to a TCP flags node and a source port node (sibling nodes).

Once this tree is generated the redundancy reduction technique starts to analyze the nodes at the bottom of the tree (farthest from the root). The analysis includes whether sibling nodes have a higher blocking rate than their parent node. If the sibling nodes have a higher blocking rate than their parent node, the traffic associated with these nodes is selected to be blocked by a mitigation action. If the parent node has a higher blocking rate, the traffic associated with the parent node is selected to be blocked by a mitigation action. This analysis continues for each level of nodes, which includes optimizing the selection of nodes at each level. The analysis ends after the root node is analyzed. In an embodiment, this technique is executed through the use of an AI model.

In another embodiment, the mitigation engine 340 may execute a greedy algorithm to ensure that the attack vectors that are selected for traffic filters have a minimal intersection (maximally disjointed). For example, a set of attack vectors with the largest blocking rate is initialized. All vectors that have no (0%) intersection with the vectors that are in the set are added to the set. Once all such vectors are added to the set, a blocking rate is calculated for the set of attack vectors. If the total blocking rate is more than 95%, the greedy algorithm ends its execution. If the blocking rate is less than 95%, other vectors that contribute to increasing the blocking rate are added until the blocking rate is 95% or there are no more vectors left to analyze. In an embodiment, this technique is executed through the use of an AI model.

The mitigation engine 340 may use traffic filters and geographic filters. Geographic filters include blocking, from certain countries, source IP addresses, or network traffic associated with a DDoS attack that also did not participate in peacetime traffic. In an embodiment, the mitigation engine 340, through the use of an AI model, receives geographical data of network traffic and the optimized attack vector list from the above techniques. The AI model outputs a recommendation for a traffic filter and a geographic filter. In an embodiment, the recommendation involves updating the security policies of the security tools 130 (FIGS. 1 and 2).

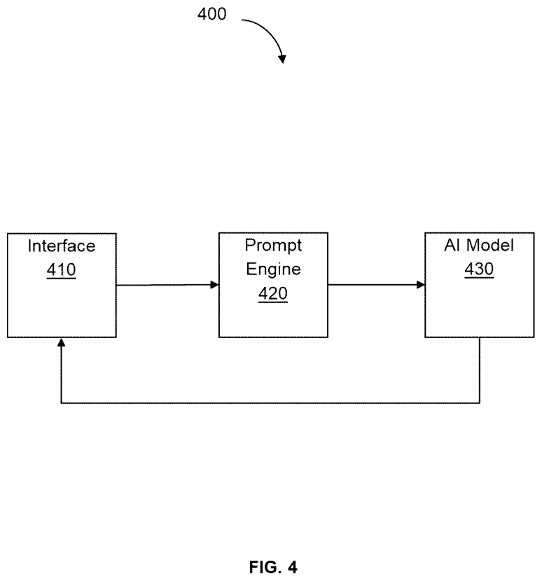

FIG. 4 shows an example functional diagram of an agent 220 according to an embodiment. Agent 220 includes an interface 410, a prompt engine 420, and an AI model 430. Interface 410 interfaces between a security tool (e.g., security tool 130) and an agent 220 to receive indicative information on a potential attack and to send configuration instructions to the respective tool. Interface 410 can also interface with the controller (230, FIG. 2) to receive metadata and queries. Interface 410 may be realized as an API.

Prompt engine 420 receives, through the interface 410, indicative information from a security tool and, optionally, metadata from agent 220. Prompts are generated to address a specific function or security tool 130 based on the indicative information. Metadata may include information that can accurately answer the prompt. Metadata can be retrieved from external sources or by querying controller 230, examples for which are provided above.

AI model 430 receives the prompt generated by prompt engine 420 and is configured to train a model to provide instructions to configure a respective security tool. In an embodiment, AI model 430 is an LLM trained on the specification of the respective security tool 130. For example, AI model 430 can be realized as GPT (such as GPT-4), BERT (Bidirectional Encoder Representations from Transformers), T5 (Text-to-Text Transfer Transformer-Google), LaMDA (Language Model for Dialogue Applications), Megatron-Turing NLG (MT-NLG), XLNet, Grok, Claude (by Anthropic), Bloom (BigScience), OPT (Open Pretrained Transformer), and the like.

As an example, indicative information may include an attack pattern (or signature) and an applied policy. The prompt would be “Generate a new security policy to block a DDoS attack having the following pattern when the following policy was not operational”. AI model 430 will generate a new policy based on the prompt received, with instructions on how to configure the security tool 130.

As another example, indicative information may include aggregated network traffic data. In an embodiment, the prompt may be “Identify features of an attack vector based on the following dimensions of network traffic data.” In another embodiment, the prompt may be “Merge identified attack vectors into a consolidated attack vector based on identified features of the attack vectors.”

In an embodiment, agent 220 can provide recommendations on how to improve security policies of security tools such that the security tools are configured to optimally mitigate various types of DDoS attacks. To this end, the AI model 430 may be trained or configured with initial security policies set for the tools. During peacetime, through interface 410, traffic patterns (or other signals) monitored by the security tools are received at the prompt engine 420. Prompts are generated to modify the policies set with the security tools 130 based on the peacetime traffic patterns. AI model 430 receives the prompt generated by prompt engine 420 and is configured to provide, based on the prompt, a set of instructions to modify the policies with the security tool(s).

In an embodiment, agent 220 can implement a RAG (Retrieval-Augmented Generation) process. A RAG process is an advanced AI framework that enhances the process of generating responses by combining two main components: retrieval and generation. Operating the RAG process is useful when an AI model, according to various embodiments, does not store all the relevant network traffic or other relevant data pertaining to an attack vector or policies of the security tools.

In an embodiment, when implementing a RAG process, agent 220 first retrieves information about the network traffic associated with a DDoS attack and the capabilities of the security tools. This retrieval may include searching the network traffic flows associated with the network devices effected by a DDoS attack. Also, this retrieval may include semantically searching relevant documents stored in the organization's repositories, vendors of the security tools, publicly available databases, and the like. The retrieval process is designed to provide the model with the most relevant and high-quality information based on the input prompt.

At the augmentation stage, the prompt, according to various embodiments, is enriched. This may involve summarizing the retrieved information, combining different data points, or using them as context for generating a final response. According to an embodiment, during the augmentation stage, prompts can be augmented with the respective network traffic, attack vectors identified in the network traffic (including any DDoS attack indicative information, or capabilities of the tools as retrieved. Alternatively or collectively, during the augmentation stage, prompts can be augmented with the respective network traffic, DDoS attack indicative information, security policies, and runtime information.

At the generation stage, AI model 430 then processes the query and the retrieved data to generate a coherent and contextually accurate response. The response is instructions to modify security policies, instructions to change parameters for better detection, or mitigation of a DDoS attack. It should be noted that the generation phase is not solely based on the training data of the model itself but also integrates the external information retrieved, which increases the factual accuracy and relevance of the output.

It should be noted that utilizing the RAG process reduces the need to fine-tune the AI model, which significantly saves on compute resources.

It should be noted that agents 220 and their components may be realized in software, firmware, hardware, or a combination thereof. In one configuration, software for implementing one or more embodiments disclosed herein may be stored in the memory or storage and processed by a processor. Software shall be construed broadly to mean any type of instructions, whether referred to as software, firmware, middleware, microcode, hardware description language, or otherwise. Instructions may include code (e.g., in source code format, binary code format, executable code format, or any other suitable format of code).

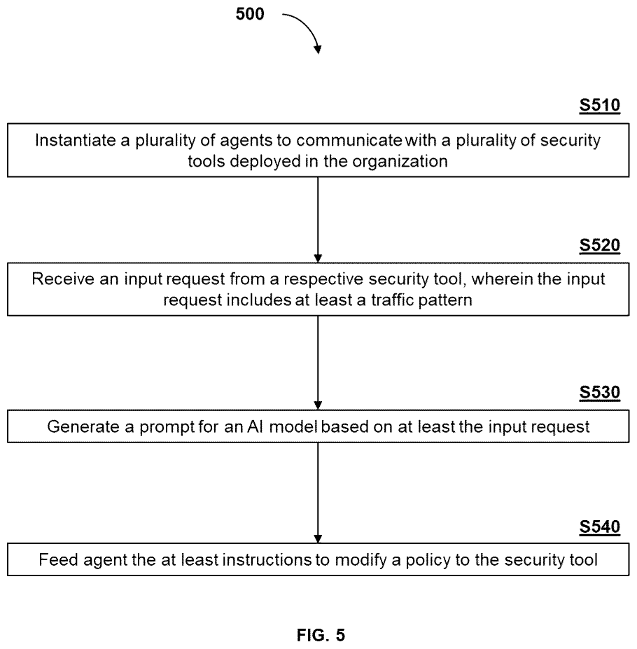

FIG. 5 is a flowchart of an example process 500 for modifying security policies of security tools to mitigate DDoS attacks according to an embodiment. In some implementations, one or more process blocks of FIG. 5 may be performed by a system, such as system 150 (FIG. 1).

At S510, a plurality of agents configured to communicate with a plurality of security tools deployed in the organization are instantiated. In an embodiment, each of the plurality of security tools defends against a different type of DDoS attack. In another embodiment, a single agent is instantiated to defend against all types of DDoS attacks. These may include network-layer DDoS attacks, web (layer 7) DDoS attacks, Botnet-based DDoS attacks, and the like.

At S520, each agent may receive an input request from a respective security tool. In an embodiment, the input request includes at least a traffic pattern. The traffic pattern may include rate-based traffic parameters, rate-invariant parameters, a communication protocol type (e.g., HTTP, HTTPs, TCP/IP, UDP, and the like), a baseline, and the like.

In an example embodiment, rate-invariant traffic parameters are network metrics that remain consistent regardless of the traffic transmission rate. Key examples include packet loss (percentage of lost packets during transmission); latency (time taken for a packet to travel from source to destination); jitter (variation in packet arrival times); throughput efficiency (proportion of network capacity effectively used for successful data transmission); error rate (frequency of transmission errors, like bit or packet errors), and the like.

In another embodiment, rate-based traffic parameters are metrics that depend on the volume or speed of data transmission in a network. Key examples include: bandwidth utilization (the percentage of the network's capacity being used); throughput (the rate of successful data transmission, measured in bits per second); traffic load (the volume of traffic on the network, in packets or bits per second); data transfer rate (the speed of data transmission between devices); packet arrival rate (the number of packets arriving per second), and the like. The baseline may be computed based on peacetime traffic. The input request may also include attributes representing attacker's activity, such as, but not limited to attributes representing attacker's activity including at least one of the logs, file changes, process behavior, and operating system events.

In one embodiment, the traffic pattern demonstrates an ongoing DDoS attack, and the input request further includes an attack-time request. The attack-time request further includes at least one of: a request to improve detection of the ongoing DDoS attack, a request to characterize the ongoing DDoS attack, and a request to improve mitigation of the ongoing cyber-attack. The attack-time request causes the modification of one or more polices related to improving detection, mitigation, and/or characterization by the respective security tool.

In another embodiment, alone or in combination with other embodiments, the traffic pattern demonstrates peacetime traffic, and the input request further includes a peacetime request. The peacetime request further includes a request to modify an initial security policy and/or a request to create a new security policy with the respective security tool.

At S530, a prompt is generated for an AI model based on at least the input request. In an embodiment, the prompt when processed by the AI model returns at least instructions to modify at least one security policy set with the security tool. In an embodiment, such instructions may include a definition of a new security policy. It should be noted that a prompt is generated by an agent and sent to the agent's AI model trained based on data of the respective security tool. In one implementation, the prompt can be generated using a RAG process.

Prompts can be generated differently for peacetime and attack-time requests. That is, for an attack-time request, S430 includes generating the prompt further based on a predefined template, the traffic pattern demonstrating the ongoing DDoS attack, the attack-time request, and metadata retrieved from external sources. An example of metadata is provided below. Alternatively, S430 includes generating the prompt further based on a predefined template, the traffic pattern demonstrating peacetime traffic, the peacetime request, and metadata retrieved from external databases. The predefined template may define a set of commands for the AI model. As an example, modify a DDoS detection policy for a device <<Device Name>> based on <<Input Pattern>> and <<Metadata>>. The Device Name, Input Pattern, and Metadata are inputs to the system.

At S540, the instructions generated by the AI model are fed to the security tool. The instructions, when executed by the security tool, cause the security tool to modify or create new security policies. In an embodiment, such instructions may cause changes in the configurations or settings of the security tools. It is important to note that modifications to security policies may occur in real-time while the incident is ongoing. Consequently, even if attackers gain an advantage in exploiting the defenses provided by security tools, the attackers cannot sustain the attack for long due to the capability to adjust security policies in real-time. Following are a few examples for modifying the policies:

To better detect a DDoS attack, a policy change may involve adjusting the detection thresholds for suspicious traffic patterns or the number of packets received from a specific source IP address.

Firewalls use policies to define rules for network traffic, specifying which connections are permitted or denied based on criteria like source and destination IP addresses, ports, and protocols. The disclosed system can generate instructions to modify these rules to block traffic from newly identified malicious sources or restrict access to sensitive systems based on observed attack patterns.

Intrusion Detection and Prevention Systems (IDPS) use rules to identify and block malicious activity. The disclosed system may generate instructions to add new rules based on the attack signature or modify existing rules to improve detection and prevention.

Process 500 may further include instantiating a controller agent to communicate with the plurality of agents. This would allow a user to submit attack reasoning queries. Such queries can be natural language queries. Examples of such queries are provided below.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

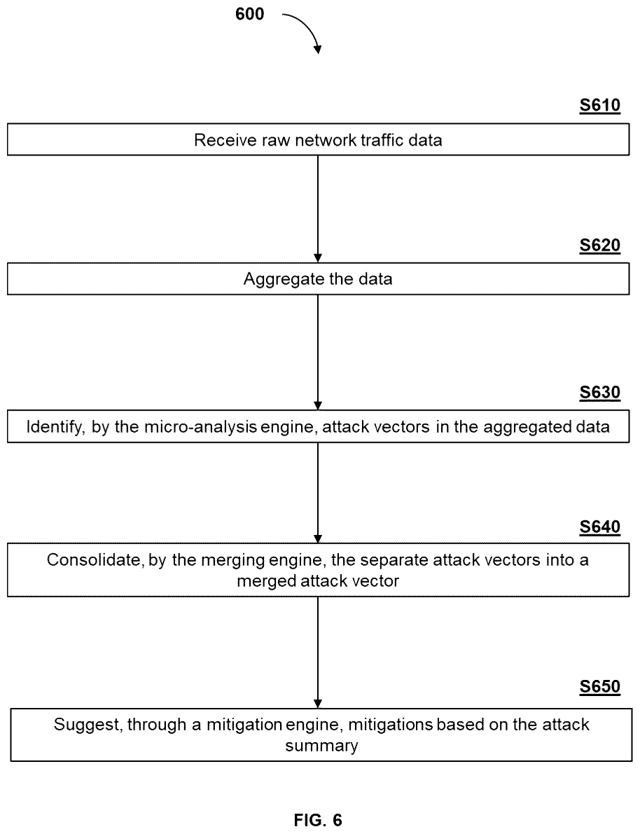

FIG. 6 is a flowchart of an example process 600 for analyzing and determining mitigation actions for DDoS attacks according to an embodiment. In some implementations, one or more process blocks of FIG. 6 may be performed by a system, such as a system 150 (FIG. 1) executing one of the agents discussed above.

At S610, traffic patterns data is received. In an embodiment, the raw traffic patterns data (or simply traffic patterns) is received by an aggregation engine (e.g., aggregation engine 310, FIG. 3). In an embodiment, the traffic patterns received from various sources including, but not limited to, any network-connected devices and the security tool (e.g., a security tool 130). Examples of traffic data patterns relevant to the disclosed system are discussed in more detail with respect to FIG. 3.

At S620, the traffic patterns are aggregated. The techniques and procedures executed by the aggregation engine are discussed in greater detail with respect to 310, FIG. 3.

In an embodiment, a prompt is generated for an AI model associated with at least one aggregation engine. According to this embodiment, the prompt may include a request to aggregate the traffic patterns, and the results returned by the prompt, when processed by the AI model, may include the aggregated data. At S630, attack vectors are identified in the aggregated data. In an embodiment, the attack vectors are separate attack vectors, each identified by a respective micro-analysis engine (e.g., micro-analysis engine 320, FIG. 3). The function of the micro-analysis engine within agent 220 is discussed in more detail in FIG. 3.

In an embodiment, a prompt is generated for an AI model associated with a micro-analysis engine. According to this embodiment, the micro-analysis engine may input a plurality of prompts to an AI model. Each prompt includes and is associated with a particular dimension of the aggregated data. The AI model, through the plurality of prompts, is configured to receive the respective dimension of aggregated data, analyze the dimension of the aggregated data, and determine an attack vector. The results of each prompt, when processed by the AI model, may include an analysis of a particular dimension of the aggregated data and an identified attack vector based on the analysis.

At S640, the separate attack vectors are consolidated into a merged attack vector. In an embodiment, the separate attack vectors are consolidated into a merged attack vector by a merging engine (e.g., merging engine 330, FIG. 3).

In an embodiment, a prompt is generated for an AI model associated with the merging engine. According to this embodiment, the prompt may include a request to receive the attack vectors identified by the AI model associated with the micro-analysis engine, to merge overlapping characteristics of the identified attack vectors, and to determine a merged attack vector. The results of the prompt, when processed by the AI model, may include a merged attack vector based on overlapping characteristics of the identified attack vectors.

In an embodiment, an attack summary is generated. According to this embodiment, the merging engine generates the attack summary. The attack summary is based on the merged attack vector. The merged attack vector may be inputted as a prompt into an AI model. The results of the prompt, when processed by the AI model, is an attack summary that displays the key characteristics of the merged attack vector.

At S650, mitigation actions are suggested based on an attack summary. As explained above, in an embodiment, the merging engine may generate an attack summary based on the merged attack vector. In an embodiment, mitigation actions to block network traffic associated with the merged attack vector are suggested, by a mitigation engine (e.g., mitigation engine 340, FIG. 3), to a security tool (e.g., security tool 130).

In an embodiment, a prompt is generated for an AI model associated with the mitigation engine. According to this embodiment, the prompt may include a request to determine a mitigation action based on the attack summary and the merged attack vector. The results returned by the prompt, when processed by the AI model, may include an instruction to modify at least one security policy set with the security tool. This instruction to modify serves to ensure that the security tool performs the most precise mitigation action without disrupting legitimate network traffic.

Process 600 may further include instantiating a controller agent to communicate with the plurality of agents. This would allow a user to submit attack reasoning queries. Such queries can be natural language queries. Examples of such queries are provided below.

It should be noted that the AI models utilized at different stages may be the same or different models. Furthermore, these models are executed by a generative AI (GenAI) system.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

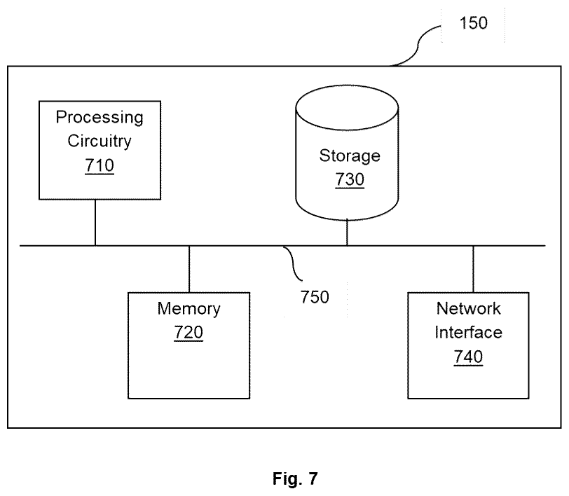

FIG. 7 is an example schematic diagram of a system 150 according to an embodiment. The system 150 includes a processing circuitry 710 coupled to a memory 720, a storage 730, and a network interface 740. In an embodiment, the components of the system 150 may be communicatively connected via a bus 750.

The processing circuitry 710 may be realized as one or more hardware logic components and circuits. For example, and without limitation, illustrative types of hardware logic components that can be used include Field Programmable Gate Arrays (FPGAs), Application-Specific Integrated Circuits (ASICs), Application-Specific Standard Products (ASSPs), System-On-a-Chip systems (SOCs), Graphics Processing Units (GPUs), Tensor Processing Units (TPUs), general-purpose microprocessors, microcontrollers, Digital Signal Processors (DSPs), specialized AI chips for real-time inference, and the like, or any other hardware logic components that can perform calculations or other manipulations of information.

The memory 720 may be volatile (e.g., random access memory, etc.), non-volatile (e.g., read-only memory, flash memory, etc.), large memory (HBM), or a combination thereof.

In one configuration, software for implementing one or more embodiments disclosed herein may be stored in the storage 730. In another configuration, the memory 720 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 710, cause the processing circuitry 710 to perform the various processes described herein.

The storage 730 may be magnetic storage, optical storage, and the like, and may be realized, for example, as flash memory or other memory technology, and fast storage (NVMe), or any other medium that can be used to store the desired information.

The network interface 740 allows the system 150 to communicate with other systems, devices, components, applications, or other hardware or software components, for example as described herein.

In at least some embodiments, the processing circuitry 710 is configured to execute generative artificial intelligence (genAI) models, perform inference using or otherwise apply genAI models, train genAI models, fine-tune genAI models, combinations thereof, and the like. Such genAI models are configured to produce text, images, videos, or other forms of data, and may include, but are not limited to, language models (for example, but not limited to, large language models, small language models, etc.), text-to-image artificial intelligence (AI) image generation systems, text-to-video AI video generators, combinations thereof, and the like. To this end, the processing circuitry 710 may be adapted to realize a transformer deep learning architecture (e.g., a generative pre-trained transformer [GPT], bidirectional encoder representations from transformers [BERT], text-to-text transfer transformer [T5], etc.), a diffusion model, both, and the like.

In accordance with various such embodiments, the hardware utilized for the processing circuitry 710 is selected in order to enable genAI functionality based on factors such as, but not limited to, parallelism (e.g., amounts of parallel processing to be performed), memory demands (e.g., amounts of random access memory [RAM] utilized to store model weights and training during processing or video RAM [VRAM] to support large language models), clock speeds, thread counts, storage (for example, to support certain amounts of storage or storage speeds), cooling (e.g., liquid cooling or air cooling systems), power supply (e.g., in order to enable a target wattage used for certain kinds of activities), networking and connectivity (e.g., in order to support seamless data transfer for deployments involving communications between or among multiple machines or clusters), combinations thereof, and the like.

In embodiments that utilize large language models (LLMs) or otherwise perform operations that may require or be enhanced through the use of parallel processing, the processing circuitry 710 may include one or more GPUs or other processing units suitable for parallel processing. Such GPUs may be configured to perform matrix multiplication operations including, but not limited to, performing dot product operations in order to support neural network operations (for example, by performing dot product operations for hidden layer computations) or performing dot product operations in an attention mechanism in order to compute a similarity score between vectors during attention weight computation. In at least some such embodiments using GPUs, the processing circuitry 710 may include a number of CPU cores that is equal to or greater than the number of GPUs in order to facilitate or otherwise support parallel processing via multiple GPUs.

It should be understood that the embodiments described herein are not limited to the specific architecture illustrated in FIG. 7, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for analyzing and determining a mitigation action for a distributed denial of service (DDoS) attack, comprising:
receiving, by an agent, an input request from a security tool, wherein the input request includes traffic patterns indicative of an ongoing DDoS attack;
generating, by the agent, a prompt for a generative AI model based on at least the input request, wherein the prompt, when processed by the generative AI model, returns a recommended mitigation action to mitigate the DDoS attack, wherein the mitigation action includes at least instructions to modify at least one security policy set with the security tool; and
feeding, by the agent, the at least instructions to the security tool, wherein the at least instructions, when executed by the security tool, cause the security tool to modify at least one security policy in real-time to mitigate the DDoS attack.

2. The method of claim 1, further comprising:
instantiating the agent to communicate with the security tool deployed in an organization, wherein the security tool detects a DDoS attack.

3. The method of claim 2, further comprising:
instantiating a plurality of agents, wherein each of the plurality of agents communicates with a different security tool configured for detecting a different type of DDoS attack.

4. The method of claim 1, wherein generating the prompt further comprises:
computing attack vectors based on the received traffic patterns.

5. The method of claim 4, wherein computing the attack vectors further comprises:
aggregating the received traffic patterns;
identifying a plurality of attack vectors in the aggregated traffic patterns;
consolidating the plurality of attack vectors into a merged attack vector; and
generating at least one mitigation action based on key characteristics of the merged attack vector.

6. The method of claim 1, wherein generating the prompt further comprises:
generating the prompt further based on a predefined template, the input request, and the merged attack vector.

7. The method of claim 1, further comprising:
configuring the agent with the generative AI model; and
training the generative AI model with security policies and capabilities of the security tool.

8. The method of claim 1, wherein the traffic patterns demonstrate an ongoing DDoS attack, and wherein the input request further includes an attack-time request.

9. The method of claim 1, wherein the request further includes any one of:
a request to improve detection of the ongoing DDoS attack, a request to characterize the ongoing DDoS attack, and a request to improve mitigation of the ongoing DDoS attack.

10. The method of claim 1, further comprising:
instantiating a controller agent to communicate with the agent; and
responding, by the controller agent, to attack reasoning queries submitted by a user.

11. The method of claim 10, wherein the queries are natural language queries.

12. The method of claim 1, wherein a traffic pattern of the input patterns in the input request includes any one of: rate-based traffic parameters, rate-invariant parameters, a communication protocol type, and a baseline determined during peacetime.

13. A non-transitory computer-readable medium storing a set of instructions, the set of instructions comprising:
one or more instructions that, when executed by one or more processors of a device, cause the device to:
A method for analyzing and determining a mitigation action for a distributed denial of service (DDoS) attack, comprising:
receive, by an agent, an input request from a security tool, wherein the input request includes traffic patterns indicative of an ongoing DDoS attack
generate, by the agent, a prompt for a generative AI model based on at least the input request, wherein the prompt, when processed by the generative AI model, returns a recommended mitigation action to mitigate the DDoS attack, wherein the mitigation action includes at least instructions to modify at least one security policy set with the security tool; and
feed, by the agent, the at least instructions to the security tool, wherein the at least instructions, when executed by the security tool, cause the security tool to modify at least one security policy in real-time to mitigate the DDoS attack.

14. A system for analyzing and determining a mitigation action for a distributed denial of service (DDoS) attack comprising:
one or more processors configured to:
receive, by an agent, an input request from a security tool, wherein the input request includes traffic patterns indicative of an ongoing DDoS attack
generate, by the agent, a prompt for a generative AI model based on at least the input request, wherein the prompt, when processed by the generative AI model, returns a recommended mitigation action to mitigate the DDoS attack, wherein the mitigation action includes at least instructions to modify at least one security policy set with the security tool; and
feed, by the agent, the at least instructions to the security tool, wherein the at least instructions, when executed by the security tool, cause the security tool to modify at least one security policy in real-time to mitigate the DDoS attack.

15. The system of claim 14, wherein the one or more processors are further configured to:
instantiate the agent to communicate with the security tool deployed in an organization, wherein the security tool detects a DDoS attack.

16. The system of claim 15, wherein the one or more processors are further configured to:
instantiate a plurality of agents, wherein each of the plurality of agents communicates with a different security tool configured for detecting a different type of DDoS attack.

17. The system of claim 14, wherein the one or more processors, when generating the prompt, are configured to:
compute attack vectors based on the received traffic patterns.

18. The system of claim 17, wherein the one or more processors, when computing the attack vectors, are configured to:
aggregate the received traffic patterns;
identify a plurality of attack vectors in the aggregated traffic patterns;
consolidate the plurality of attack vectors into a merged attack vector; and
generate at least one mitigation action based on key characteristics of the merged attack vector.

19. The system of claim 14, wherein the one or more processors, when generating the prompt, are configured to:
generate the prompt further based on a predefined template, the input request, and the merged attack vector.

20. The system of claim 14, wherein the one or more processors are further configured to:
configure the agent with the generative AI model; and
train the generative AI model with security policies and capabilities of the security tool.

21. The system of claim 14, wherein the traffic patterns demonstrate an ongoing DDoS attack, and wherein the input request further includes an attack-time request.

22. The system of claim 14, wherein the request further includes any one of:
a request to improve detection of the ongoing DDoS attack, a request to characterize the ongoing DDoS attack, and a request to improve mitigation of the ongoing DDoS attack.

23. The system of claim 14, wherein the one or more processors are further configured to:
instantiate a controller agent to communicate with the agent; and
respond, by the controller agent, to attack reason queries submitted by a user.

24. The system of claim 23, wherein the queries are natural language queries.

25. The system of claim 14, wherein a traffic pattern of the input patterns in the input request includes any one of:
rate-based traffic parameters, rate-invariant parameters, a communication protocol type, and a baseline determined during peacetime.
